(19) United States
(12) Patent Application Publication
(10) Pub. No.: US 2012/0201066 A1
(43) Pub. Date: Aug. 9, 2012

(54) DUAL SWITCHING FREQUENCY HYBRID POWER CONVERTER

(76) Inventors: Maxime R. DUBOIS, Levis (CA); Michael DESJARDINS, Quebec (CA); Louis TREMBLAY, Quebec (CA)

(21) Appl. No.: 13/306,766

(22) Filed: Nov. 29, 2011

Related U.S. Application Data
(63) Continuation-in-part of application No. PCT/CA2010/000919, filed on Jun. 15, 2010.
Application No. PCT/CA2010/000919 is a continuation-in-part of application No. PCT/CA2010/000922, filed on Jun. 15, 2010.
(60) Provisional application No. 61/187,170, filed on Jun. 15, 2009.
(60) Provisional application No. 61/233,664, filed on Aug. 13, 2009.
(60) Provisional application No. 61/187,170, filed on Jun. 15, 2009.
(60) Provisional application No. 61/187,174, filed on Jun. 15, 2009.
(60) Provisional application No. 61/187,176, filed on Jun. 15, 2009.
(60) Provisional application No. 61/233,664, filed on Aug. 13, 2009.

(51) Int. Cl. H02M 7/797; H02M 7/217; H02M 7/537; H02M 7/00

(52) U.S. Cl. 363/127; 363/123; 363/131

(57) ABSTRACT

A dual switching frequency hybrid power converter comprising two different types of power switching element switching at two different frequencies is presented for DC-to-AC and AC-to-DC voltage conversion and for monophase or multi-phase devices with the aim of reducing considerably the conduction and switching losses of those power switching elements. The dual switching frequency hybrid power converter also enables a DC to DC voltage conversion as well as an AC to AC voltage conversion.

### CROSS REFERENCE TO RELATED APPLICATIONS

This application is a Continuation-in-Part Application of PCT International Application No. PCT/CA2010/000919, entitled “DUAL SWITCHING FREQUENCY HYBRID POWER CONVERTER”, International Filing Date Jun. 15, 2010, published on Dec. 23, 2010 as International Publication No. WO 2010/145019, which in turn claims priority from U.S. Provisional Patent Application No. 61/187,170, filed Jun. 15, 2009 and U.S. Provisional Patent Application No. 61/233,664, filed Aug. 13, 2009, all of which are incorporated herein by reference in their entirety.

This application is a Continuation-in-Part Application of PCT International Application No. PCT/CA2010/000922, entitled “ENERGY STORAGE SYSTEM AND METHOD”, International Filing Date Jun. 15, 2010, published on Dec. 23, 2010 as International Publication No. WO 2010/145021, which in turn claims priority from U.S. Provisional Patent Application No. 61/187,170, filed Jun. 15, 2009, U.S. Provisional Patent Application No. 61/187,174, filed Jun. 15, 2009, U.S. Provisional Patent Application No. 61/187,176, filed Jun. 15, 2009 and U.S. Provisional Patent Application No. 61/233,664, filed Aug. 13, 2009, all of which are incorporated herein by reference in their entirety.

### FIELD OF THE INVENTION

The invention relates to electric converters for AC to DC and DC to AC voltage conversion for mono-phase or multi-phase systems, and more particularly concerns a dual switching frequency hybrid power converter enabling to reduce conduction and commutation losses.

### BACKGROUND OF THE INVENTION

With the rising costs and demand of energy, power electronics will have a predominant role to play to transmit and control the flow of energy in the most efficient way.

Actually, two of the main reasons for the relatively slow adoption of electric converters are their high cost and their lack of reliability in certain circumstances.

To reduce the costs, the use of passive components (inductor and capacitance, mainly for filtering) must be minimized and integrated in the packaging of the converter. The lack of reliability is caused principally by the junction temperature of the semiconductor (power transistor).

One way generally employed in industry to reduce the size of the passive components is by increasing the switching frequency of the converter since their size is decreasing when the switching frequency increases. The trade-off, however, is the increase of the switching losses incurred and the increase of the power transistor temperature. Thus, the space saved by the smaller passive components is more than offset by the need for larger heat sink for evacuating these losses.

FIG. 1 illustrates the general topology of a three phase DC-to-AC converter (known as inverter) with six switches, six anti-parallel diodes, an input capacitor and a DC source voltage. This converter may also be used to rectify an AC voltage to a DC voltage too. The switches S1 (high-side) and S4 (low-side) form a unit commonly called an inverter leg. A full-bridge mono-phase inverter comprises two inverter legs while a three-phase inverter comprises three legs.

FIG. 2 and FIG. 3 are examples of inverters used with the two most common power transistors generally known in the art, that is the MOSFETs (Metal Oxide Semiconductor Field Effect Transistor) in the FIG. 3 and the IGBTs (Insulated Gate Bipolar Transistor) in the FIG. 2.

FIG. 4 shows a one phase inverter with an R-L load (R=35 Ω and L=20 mH as a non-limitative example) that will be referred to explain the general principle of the conversion from a DC voltage to an AC voltage. In the illustrated case, the load is resistive/inductive like most of the loads on electrical networks, such as the electric motors/generators for example. The goal of an inverter is to produce an AC voltage from a DC voltage. In the illustrated embodiment, S1 and S3 form a first leg while S2 and S4 form a second leg.

FIG. 5 and FIG. 6 show one of the many ways for generating the control signals used to operate the power switches S1 to S4 of the converter shown in FIG. 4. It is however worth mentioning that in order to simplify the understanding, the load will be first considered as being resistive only. In other words, the phase difference between the voltage and the current across the load will not be taken into consideration firstly.

In FIG. 5, a sinusoidal reference is compared with a triangular carrier signal to produce the high-side and low-side control signals used to respectively operate the high side and low side switches S1 and S3 of the first leg of the converter shown in FIG. 4. When the sinusoidal reference is greater than the carrier signal, the control signal for S1 is high (a logic 1) and when the sinusoidal reference is lower than the carrier signal, the control signal for S1 is low (a logic 0). As shown on the lower graph of FIG. 5, when the sinusoidal reference is greater than the carrier signal, the control signal for S3 is low (a logic 0) and when the sinusoidal reference is lower than the carrier signal, the control signal for S3 is high (a logic 1). Consequently, a single one of the switches S1 and S3 is activated at the same time.

FIG. 6 shows the generation of the control signals for the high side and low side switches S2 and S4 of the second leg of the converter shown in FIG. 4. As illustrated, the sinusoidal reference used in FIG. 5 is inverted and compared to the same triangular carrier signal. This method is referred to as Unipolar Pulse-Width Modulation (UPWM). It can be seen that a single one of the switches S2 and S4 is activated at the same time.

FIG. 7 shows the four controls signals previously described necessary to switch on and off the switches S1 to S4 to obtain a current of sinusoidal waveform at the load.

Referring again to FIG. 4, the current across the inductor L is defined as follows:

$$iL ( t ) = \frac{1}{L} \int {V}_{L} ( t ) d t \qquad ( 1 )$$

when V_{L} is continuous,

$$iL ( t ) = \frac{{V}_{L}}{L} t \qquad ( 2 )$$

i_{L} increase linearly when V_{L} is positive and decrease linearly when V_{L} is negative.

The voltage across the inductance L is defined as follows:

$${V}_{L} = L \frac{d iL}{d t} \qquad ( 3 )$$

In the case of an R-L load like illustrated in FIG. 4:

$$iL ( t ) = \frac{{V}_{RL}}{R} ( 1 - {e}^{- \frac{R}{L} t} ) \qquad ( 4 )$$

with i_{L}(0)=0.

FIG. 8 is an enlarged view of a first portion (circled) of the control signals shown in FIG. 7. In section 1 of FIG. 8, the control signals of the switches S1 and S4 are high so that S1 and S4 conduct, as illustrated in FIG. 10A. The voltage across the inductor is positive and the current i_{L} is increasing exponentially (exponential approach), as better shown in section 1 of FIG. 9.

In this case, V_{D1}=V_{D4}=0 and V_{D2}=V_{D3}=−V_{dc} (<0), the diodes don't conduct.

In section 2 of FIG. 8, S1 is turned OFF, S4 is still ON and S3 is turned ON. At the time the switch S1 is turned OFF, the current i_{L} is interrupted and a very large and negative voltage appears across the inductor

$$( \frac{d iL}{d t} \to - ∞ )$$

and V_{L}=−∞ (equation 3). V_{D3}=−V_{R}+∞=∞. If V_{D3}>0, D3 conducts immediately.

The voltage across the diode D3 becomes positive and D3 begins to conduct. V_{D4}=0 and V_{D1}=V_{D2}=−V_{dc} (<0), the diodes D4, D1 and D2 don't conduct, as better shown in FIG. 10B. The voltage across the inductor is now −V_{R}=i_{L}*R. The current decreases exponentially, as better shown in section 2 of FIG. 9.

In section 3 of FIG. 8, the switches S1 to S4 are in the same configuration as the one illustrated in section 1. The switches S1 and S4 conduct, as illustrated in FIG. 10C, and the voltage across the inductor is positive. The current i_{L} is increasing exponentially (exponential approach), as better shown in section 3 of FIG. 9.

In section 4 of FIG. 8, S4 is turned OFF, S1 is still ON and S2 is turned ON. At the time the switch S4 is turned OFF, the current i_{L} is interrupted and a very large and negative voltage appears across the inductor

$$( \frac{d iL}{d t} \to - ∞ )$$

and V_{L}=−∞ (equation 3). V_{D2}=−V_{R}+∞=∞. If V_{D2}>0, D2 conducts immediately.

The voltage across the diode D2 becomes positive and D2 begins to conduct. V_{D1}=0 and V_{D3}=V_{D4}=−V_{dc} (<0), the diodes D1, D3 and D4 don't conduct, as better shown in FIG. 10D. The voltage across the inductor is now −V_{R}=i_{L}*R. The current decreases exponentially, as better shown in section 4 of FIG. 9.

The above described sequences are repeated as long as the current at the load is positive. As it is shown in FIG. 7, the width of the signals for the switches S1 to S4 may be changed to obtain a sinusoidal current at the load.

FIG. 14 illustrates the current across the load and the voltage V_{RL} at the load. The skilled addressee will appreciate that the phase difference between the voltage and the current across the load has still not be taken into consideration.

FIG. 11 is an enlarged view of a second portion (circled) of the control signals shown in FIG. 7. In other words, it illustrates the control signals of the switches S1 to S4 when the current at the load is negative.

In section 5 of FIG. 11, the control signals of the switches S3 and S2 are high so that S2 and S3 conduct, as illustrated in FIG. 13A. The voltage across the inductor is negative and the current i_{L} is decreasing exponentially, as better shown in section 5 of FIG. 12.

In this case, V_{D2}=V_{D3}=0 and V_{D1}=V_{D4}=V_{dc} (<0), the diodes don't conduct.

In section 6 of FIG. 11, S2 is turned OFF, S3 is still ON and S4 is turned ON. At the time the switch S2 is turned OFF, the current i_{L} is interrupted and a very large and positive voltage appears across the inductor

$$( \frac{d iL}{d t} \to - ∞ )$$

and V_{L}=∞ (equation 3). V_{D4}=−V_{R}+∞=∞ (V_{D4}>0, D4 conducts immediately).

The voltage across the diode D4 becomes positive and D4 begins to conduct. V_{D3}=0 and V_{D1}=V_{D2}=V_{dc} (<0), the diodes D3, D1 and D2 don't conduct, as better shown in FIG. 13B. The voltage across the inductor is now −V_{R}=−i_{L}*R. The current increases exponentially, as better shown in section 6 of FIG. 12.

In section 7 of FIG. 11, the switches S2 and S3 are in the same configuration as the one illustrated in section 5. The switches S2 and S3 conduct, as illustrated in FIG. 13C, and the voltage across the inductor is negative. The current i_{L} is decreasing exponentially, as better shown in section 7 of FIG. 12.

In section 8 of FIG. 11, S3 is turned OFF, S2 is still ON and S1 is turned ON. At the time the switch S3 is turned OFF, the current i_{L} is interrupted and a very large and positive voltage appears across the inductor

$$( \frac{d iL}{d t} \to - ∞ )$$

and V_{L}=∞(equation 3). V_{D1}=V_{R}+∞=∞. If V_{D1}>0, D1 conducts immediately.

The voltage across the diode D1 becomes positive and D1 begins to conduct. V_{D2}=0 and V_{D3}=V_{D4}=−V_{dc} (<0), the diodes D2, D3 and D4 don't conduct, as better shown in FIG. 13D. The voltage across the inductor is now −V_{R}=−iL*R. The current increases exponentially, as better shown in section 8 of FIG. 12.

In FIGS. 14 and 15, it can be seen that the method described above generates a sinusoidal waveform when filtered by a low-pass filter such as an R-L load. The waveform of FIG. 15 is a lot smoother than the one shown in FIG. 14. Indeed, the difference is that in FIG. 14, the switching frequency is 480 Hz and in FIG. 15, the switching frequency is 20 kHz.

The skilled addressee will appreciate that, in order to be able to use inverters on the electrical network, distortions on the output voltage and current must be minimized to an acceptable level, and the more the switching frequency is low, the more the inductor (L) has to be large to keep distortions low. Inversely, to have a small inductor and thus reduced inverter volume and cost, switching frequency has to be increased.

Since switching losses are proportional to the switching frequency, they are increased as the switching frequency is also increased. Thus, the use of an increased switching frequency generates an increase in power output losses of the inverter.

It would therefore be desirable to provide an improved inverter, also called a converter, that will reduce at least one of the above mentioned drawbacks.

### BRIEF SUMMARY

Accordingly, there is provided a dual switching frequency hybrid power converter adapted to be connected between a first element and a second element for voltage conversion.

The dual switching frequency hybrid power converter comprises a first leg electrically connected to the first element, the first leg comprising a high side switch and a low side switch serially connected. The high side switch comprises a selected one of a first switching element having low conduction losses and a second switching element having low commutation losses. The low side switch comprises the remaining of a first switching element having low conduction losses and a second switching element having low commutation losses. The first leg further comprises an anti-parallel diode operatively connected in a parallel relationship with the first switching element. In other words, the first leg comprises a first switching element and a second switching element serially connected. If a first switching element is selected for the high side switch, then a second switching element has to be selected for the low side switch, and vice versa.

The dual switching frequency hybrid power converter comprises a second leg electrically connected to the first element in a parallel relationship with the first leg, the second leg comprising a high side switch and a low side switch serially connected. The high side switch comprises a selected one of a first switching element having low conduction losses and a second switching element having low commutation losses corresponding to the one selected for the high side switch of the first leg. The low side switch of the second leg comprises the remaining of a first switching element having low conduction losses and a second switching element having low commutation losses. The second leg further comprises an anti-parallel diode operatively connected in a parallel relationship with the first switching element of the second leg. In other words, the second leg comprises a first switching element and a second switching element serially connected. The type of the switching element that is selected for the high side switch of the second leg is the same that the one that is selected for the high side switch of the first leg. If a first switching element is selected for the high side switch of the second leg, then a second switching element has to be selected for the low side switch of the second leg, and vice versa.

Each of the first switching elements, which have low conduction losses, is operated at a low fundamental frequency, i.e. at a low commutation speed, and each of the second switching elements, which have low commutation losses, is operated at a high frequency, i.e. at a high commutation speed, greater than the low fundamental frequency for enabling a bidirectional voltage conversion between the first element and the second element.

The dual switching frequency hybrid power converter uses each type of the switching element in its optimal operating range of frequency, thereby enabling to reduce the output losses of the converter, which is of great advantage.

Moreover, the dual switching frequency hybrid power converter may present an improved reliability over the devices of the prior art, in minimizing the junction temperature of the semiconductor used, which is of great advantage.

Furthermore, the dual switching frequency hybrid power converter may enable to reduce the size of the passive components used for filtering, by enabling a high switching frequency. The cost of the converter may thus be reduced, which is of great advantage.

In one embodiment, each of the first switching elements comprises at least one IGBT.

In a further embodiment, each of the second switching elements comprises at least one MOSFET.

In still a further embodiment, the first switching element is selected from a group comprising a thyristor, a GTO, an IGCT and a MCT

In one embodiment, each of the first switching elements comprises a plurality of switching devices connected in parallel.

In another embodiment, each of the second switching elements comprises a plurality of switching devices connected in parallel.

In one embodiment, the corresponding anti-parallel diode is integrated with the corresponding first switching element.

In one embodiment, each of the first leg and second leg comprises an additional anti-parallel diode operatively connected in a parallel relationship with the corresponding second switching element.

In a further embodiment, the dual switching frequency hybrid power converter further comprises a third leg electrically connected to the first element in a parallel relationship with the first leg and the second leg, the third leg comprising a high side switch and a low side switch serially connected, the high side switch comprising a selected one of a first switching element having low conduction losses and a second switching element having low commutation losses corresponding to the one selected for the high side switch of the first leg and the low side switch comprising the remaining of a first switching element having low conduction losses and a second switching element having low commutation losses, the third leg further comprising an anti-parallel diode operatively connected in a parallel relationship with the first switching element, thereby providing a three phase power converter.

In one embodiment, the low fundamental frequency is comprised between 1 Hz and 1000 Hz. In a further embodiment, the low fundamental frequency is 60 Hz while in another embodiment, the low fundamental frequency is 50 Hz.

In one embodiment, the high frequency is comprised between 1 kHz and 1 MHz.

In a further embodiment, the dual switching frequency hybrid power converter further comprises a control unit controlling a plurality of control signals, each of the control signals controlling operation of a corresponding one of the switching elements.

In one embodiment, the first element comprises a DC element.

In a further embodiment, the second element comprises an AC element.

In one embodiment, the first element comprises a DC element and the second element comprises an AC element, the power converter enabling a bidirectional DC/AC voltage conversion.

According to another aspect, there is also provided a three-phase dual switching frequency hybrid power converter for a three-phase load. The three-phase power converter comprises a first, a second and a third dual switching frequency hybrid power converter as previously defined, each being operatively connected to a corresponding phase of the three-phase load.

According to another aspect, there is also provided a use of the dual switching frequency hybrid power converter as previously defined for converting an AC voltage into a DC voltage.

According to another aspect, there is also provided a use of the dual switching frequency hybrid power converter as previously defined for converting a DC voltage into an AC voltage.

According to another aspect, there is also provided a use of the dual switching frequency hybrid power converter as previously defined for converting an AC voltage into another AC voltage.

According to another aspect, there is also provided a use of the dual switching frequency hybrid power converter as previously defined for converting a DC voltage into another DC voltage.

According to another aspect, there is also provided a method for voltage conversion between a first element and a second element, the method comprising providing a dual switching frequency hybrid power converter as previously defined; operatively connecting the dual switching frequency hybrid power converter between the first element and the second element; generating a plurality of control signals, each being adapted for controlling a corresponding one of the switching elements; and applying the control signals to the corresponding switching elements to thereby enable the voltage conversion between the first element and the second element.

### BRIEF DESCRIPTION OF THE DRAWINGS

In order that the invention may be readily understood, embodiments of the invention are illustrated by way of example in the accompanying drawings.

FIG. 1 shows a typical topology of a three phase DC-to-AC converter.

FIG. 2 shows a three phase DC-to-AC converter wherein the switching elements are MOSFETs.

FIG. 3 shows a three phase DC-to-AC converter wherein the switching elements are IGBTs.

FIG. 4 shows a typical topology of a one phase converter with an R-L load.

FIG. 5 shows reference signals used to produce control signals operating switching elements S1 and S3 of FIG. 4, according to one embodiment.

FIG. 6 shows reference signals used to produce control signals operating switching elements S2 and S4 of FIG. 4, according to one embodiment.

FIG. 7 shows control signals operating switching elements S1 to S4 of FIG. 4, according to one embodiment.

FIG. 8 is an enlarged view of a first portion of the control signals shown in FIG. 7.

FIG. 9 shows the current and voltage signals of the load RL of the converter of FIG. 4 for the first portion of the control signals shown in FIG. 8.

FIGS. 10A to 10D illustrate the operation of the switching elements S1 to S4 of FIG. 4 for the portion of the control signals shown in FIG. 8, according to one embodiment.

FIG. 11 is an enlarged view of a second portion of the control signals shown in FIG. 7.

FIG. 12 shows the current and voltage signals of the load RL of the converter of FIG. 4 for the second portion of the control signals shown in FIG. 11.

FIGS. 13A to 13D illustrate the operation of the switching elements S1 to S4 of FIG. 4 for the portion of the control signals shown in FIG. 11, according to one embodiment.

FIG. 14 shows the current and voltage signals of the load RL of the converter of FIG. 4 when filtered by a low-pass filter at a switching frequency of 480 Hz, according to one embodiment.

FIG. 15 shows the current and voltage signals of the load RL of the converter of FIG. 4 when filtered by a low-pass filter at a switching frequency of 20 kHz, according to one embodiment.

FIGS. 16 and 17 illustrate the general principles of the losses of a switching element.

FIG. 18 shows the general topology of a mono-phase dual switching frequency hybrid power converter according to an embodiment of the invention.

FIG. 19 illustrates the principle of the control of the switching elements of the converter of FIG. 18, according to one embodiment.

FIG. 20 shows a three-phase dual switching frequency hybrid power converter according to an embodiment of the invention.

FIG. 21 shows reference signals used to produce control signals operating switching elements S1 and S4 of FIG. 18, according to one embodiment.

FIG. 22 shows reference signals used to produce control signals operating switching elements S2 and S3 of FIG. 18, according to one embodiment.

FIG. 23 shows control signals operating switching elements S1 to S4 of FIG. 18, according to one embodiment.

FIG. 24A to 24D illustrates a sequence of the control of the switching elements S1 to S4 of the converter of FIG. 18, according to one embodiment.

FIG. 25 illustrates the overall losses for different configurations of a three-phase converter for a switching frequency of 20 kHz.

FIG. 26 illustrates the overall losses for different configurations of a three-phase converter for a switching frequency of 200 kHz.

FIG. 27 shows a mono-phase dual switching frequency hybrid power converter according to another embodiment of the invention.

FIG. 28 illustrates the voltage and the current across the load shown in FIG. 27.

FIGS. 29A and 29B show a portion of a sequence for controlling the switching elements of the converter of FIG. 27, according to one embodiment.

FIG. 30 illustrates the current across an inductive load, according to one embodiment.

FIGS. 31A and 31B show a portion of a sequence for controlling the switching elements of the converter of FIG. 27, according to another embodiment.

FIG. 32 shows control signals operating switching elements S1 to S4 of FIG. 27, according to one embodiment.

FIG. 33 illustrated a three-phase power converter, according to one embodiment.

FIGS. 34A and 34B are tables showing the overall losses for a typical power converter and a dual switching frequency hybrid power converter, according to one embodiment.

FIG. 35 is a flow chart illustrating an embodiment of a method for voltage conversion between a first element and a second element.

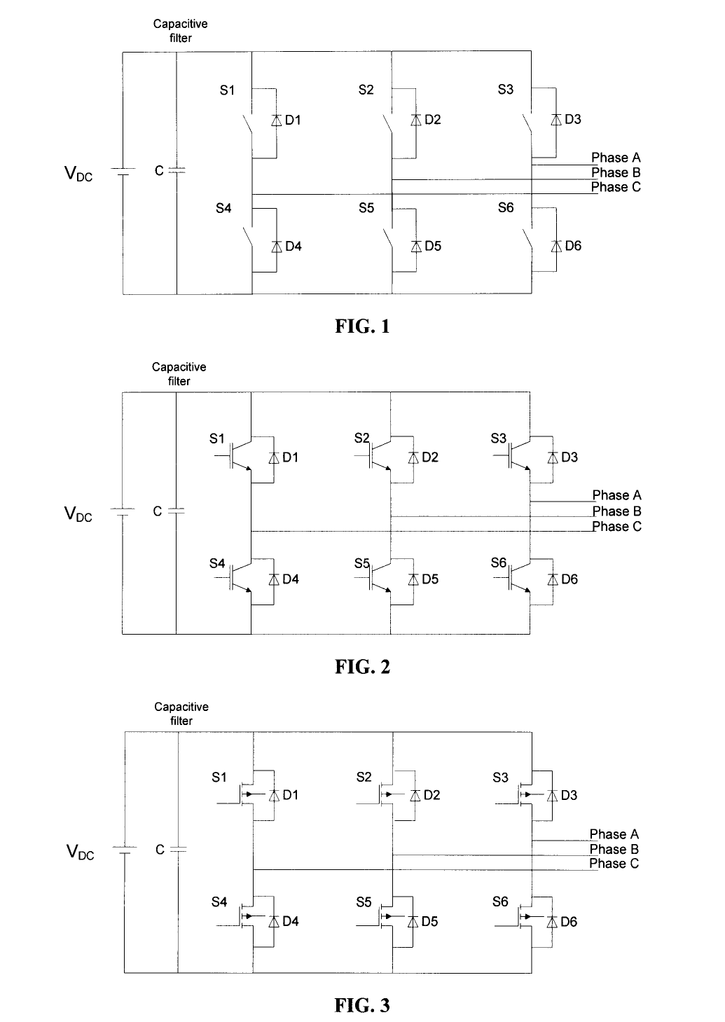

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

As previously described, the power converters of the prior art generally use a single type of switching elements for effecting the power conversion. Switching elements presenting low conduction losses such as the IGBTs however present a low commutation speed and high commutation losses. On the other hand, switching elements presenting low commutation losses such as the MOSFETs however present high conduction losses.

Moreover, as known to the skilled addressee, each of the IGBT and the MOSFET may be provided with an integrated anti-parallel diode. While the diode integrated to an IGBT generally presents a fast operating speed, the diode integrated to a MOSFET has a much more lower operating speed.

According to one embodiment, a hybrid converter is disclosed which uses two different types of switching elements and wherein each type of switching element is used in an optimal configuration to reduce the overall output losses of the converter.

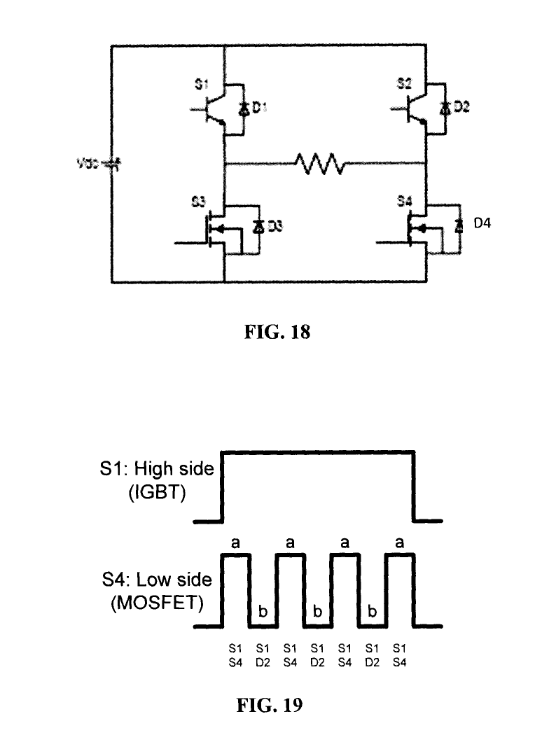

Referring to FIG. 18, there is shown a mono-phase dual switching frequency hybrid power converter according to an embodiment of the invention. As illustrated, the converter uses two different types of switching elements: a first switching element having low conduction losses such as an IGBT and a second switching element having low commutation losses such as a MOSFET. The load is a resistive load.

Throughout the present description, exemplary embodiments of the dual switching frequency hybrid power converter will be described with IGBTs as the first switching elements and MOSFETs as the second switching elements but the skilled addressee will appreciate that other arrangements may be considered, as long as the first switching elements have suitable low conduction losses and the second switching elements have suitable low commutation losses. For non-limitative examples, thyristors, GTO, IGCT, MCT or specific types of MOSFETS presenting low conduction losses may be used for the first switching elements. Moreover, specific fast IGBTs may be used for the second switching elements.

As it will be more clearly detailed below, the MOSFETs, i.e. the second switching elements, are switched at a high frequency since they are fast and present low commutation losses while the IGBTs are switched at a low frequency since they are much slower. Moreover, in order to reduce even more the overall losses of the converter, the IGBTs, which have low conduction losses, are used more often than the MOSFETs, i.e. they are more often in a conduction state than the MOSFETs, as shown in FIG. 19 and detailed below.

Moreover, in one embodiment, for example in the case the load is a resistive load only, the anti-parallel diodes that are generally integrated to the MOSFETs are not used, which is of great advantage since they are slow and dissipative when switched at a high frequency. As it will be more clearly understood upon reading of the present description, the described topology becomes even more advantageous when a plurality of MOSFETs is connected in a parallel relationship to provide more current power.

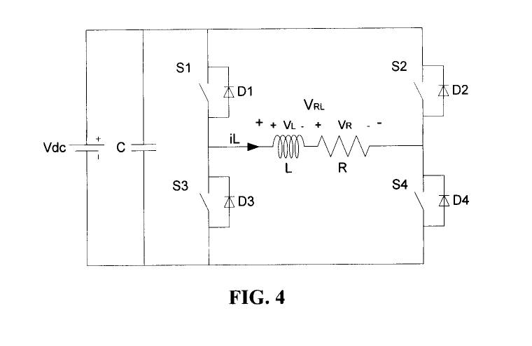

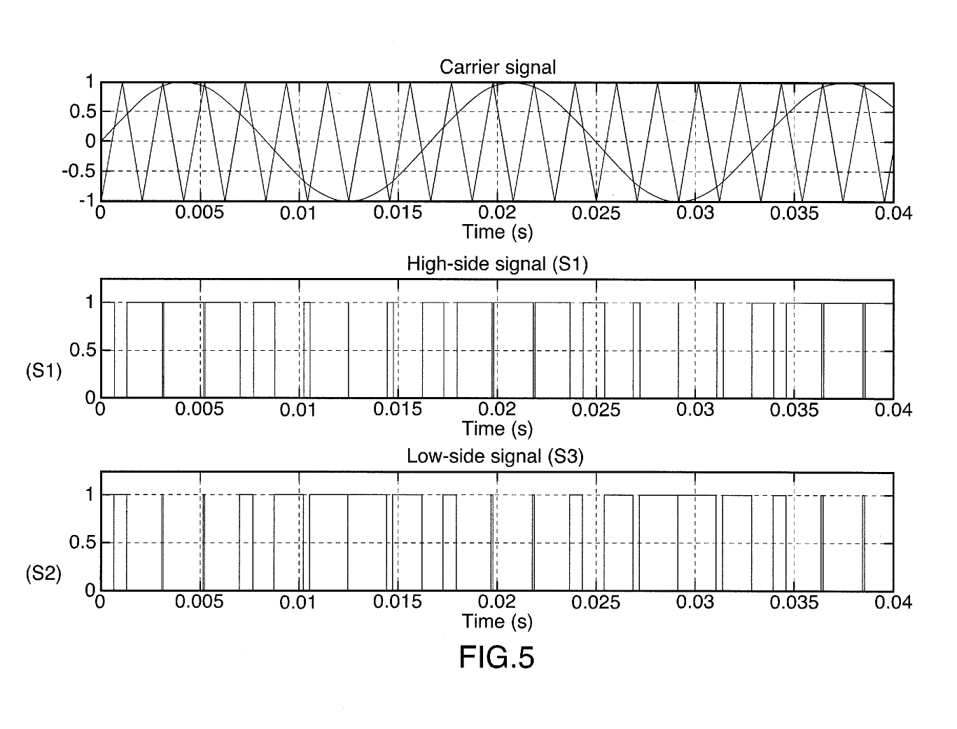

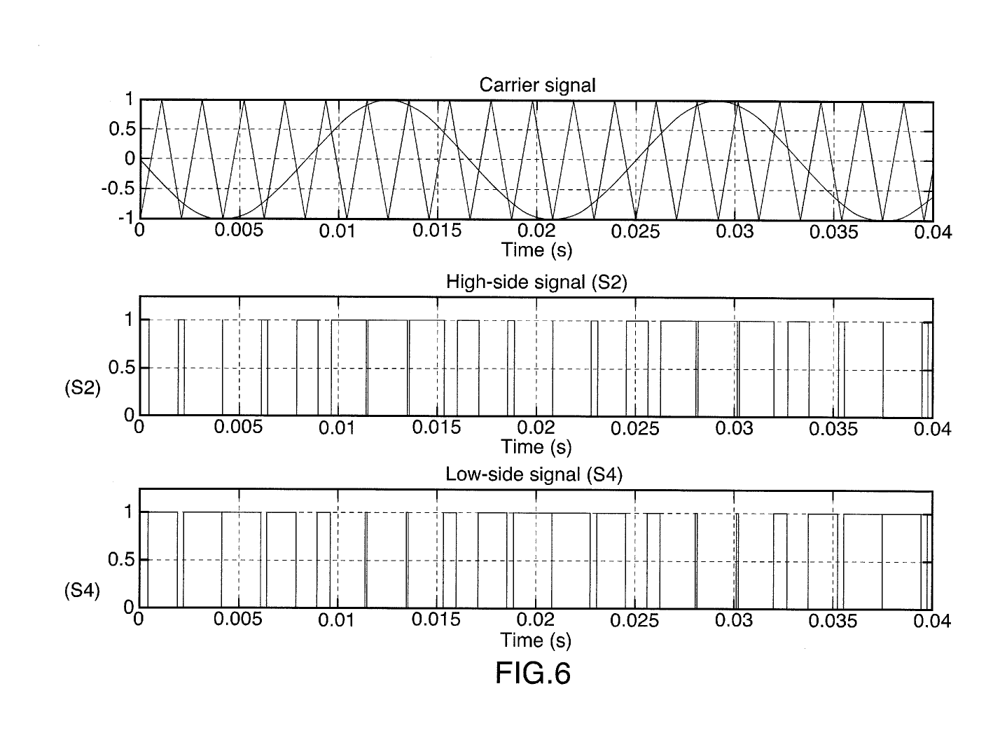

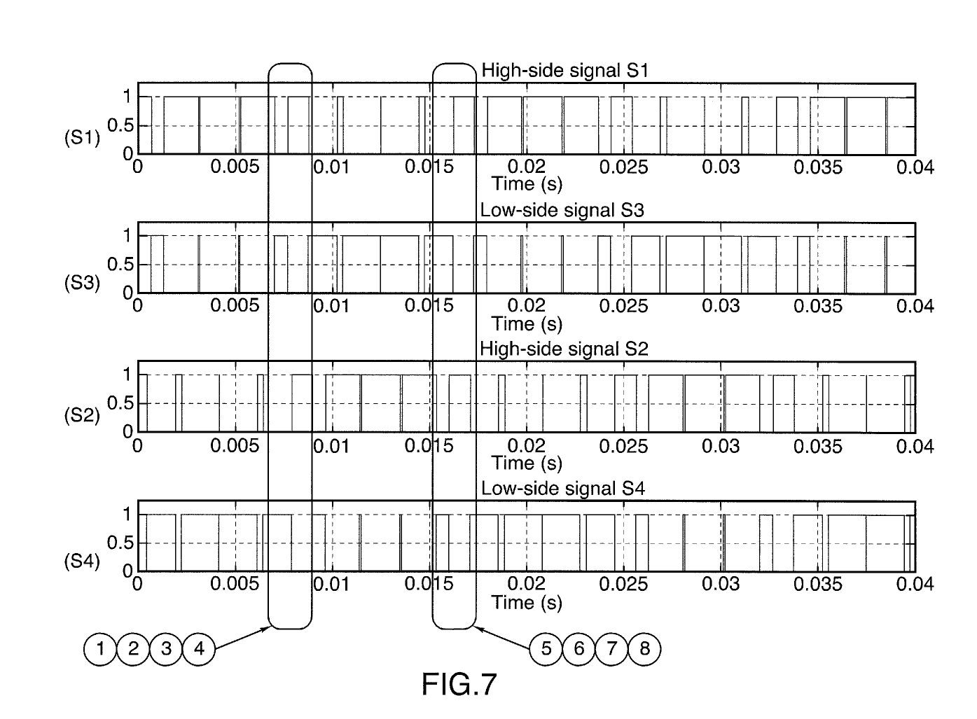

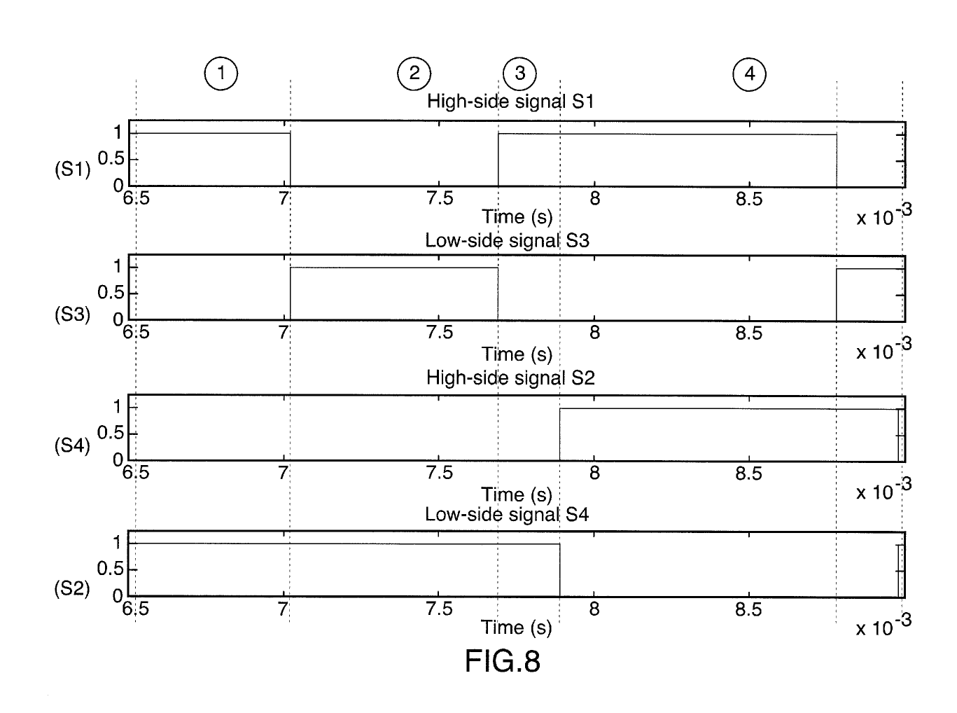

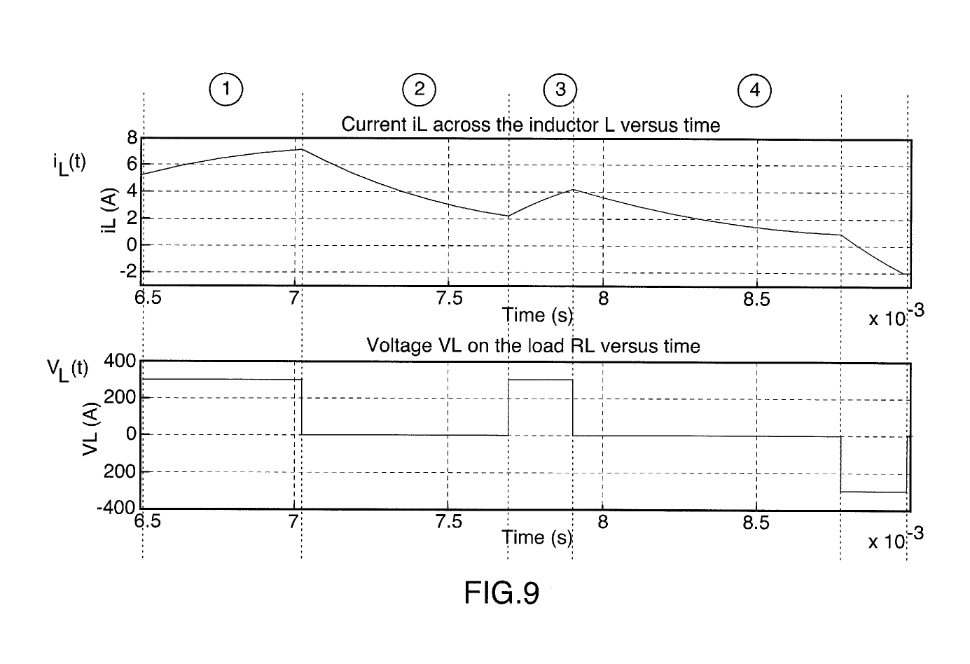

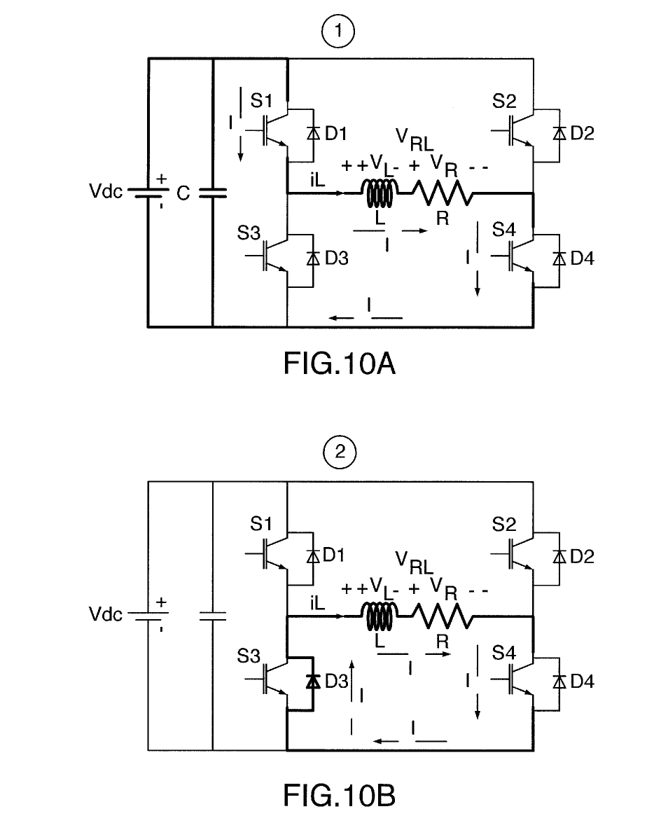

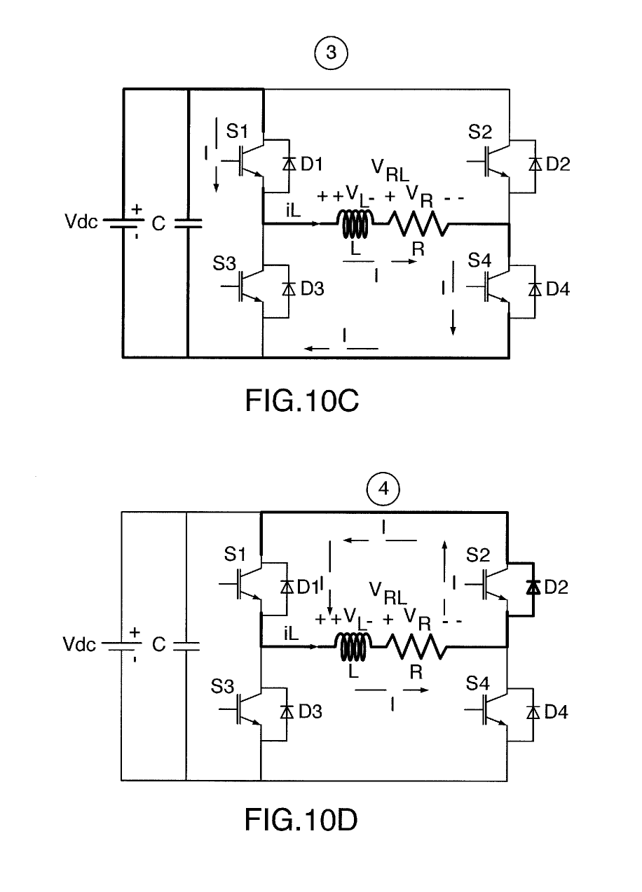

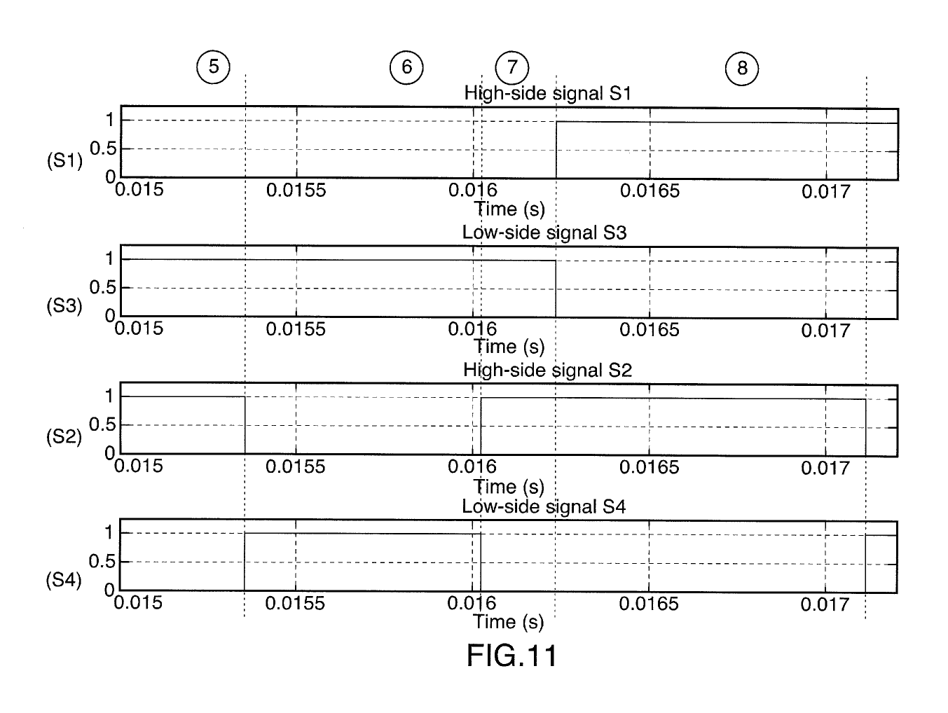

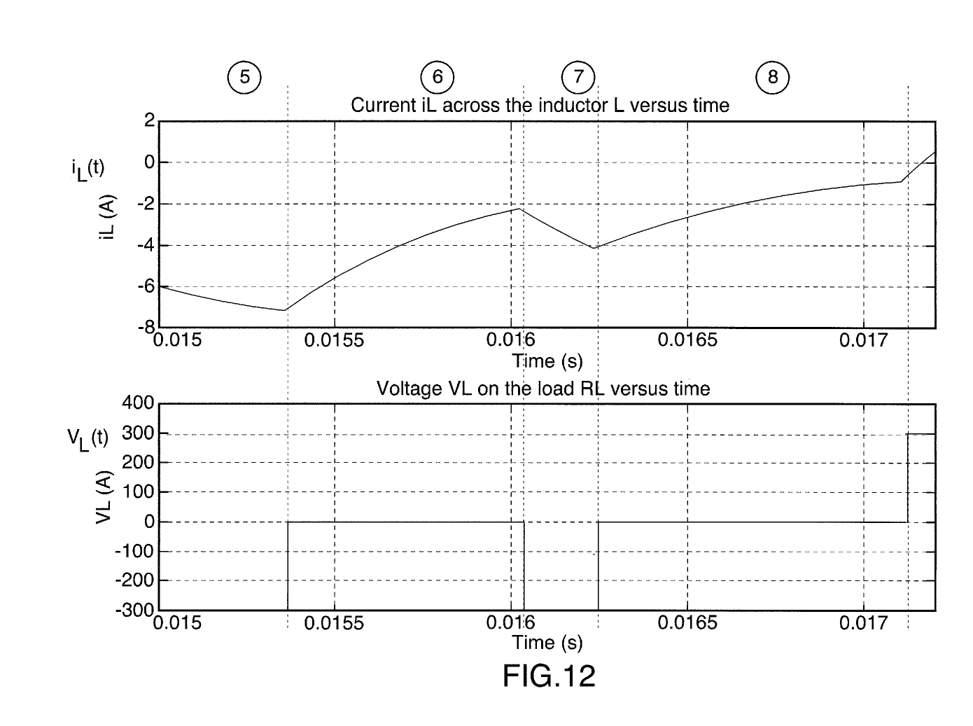

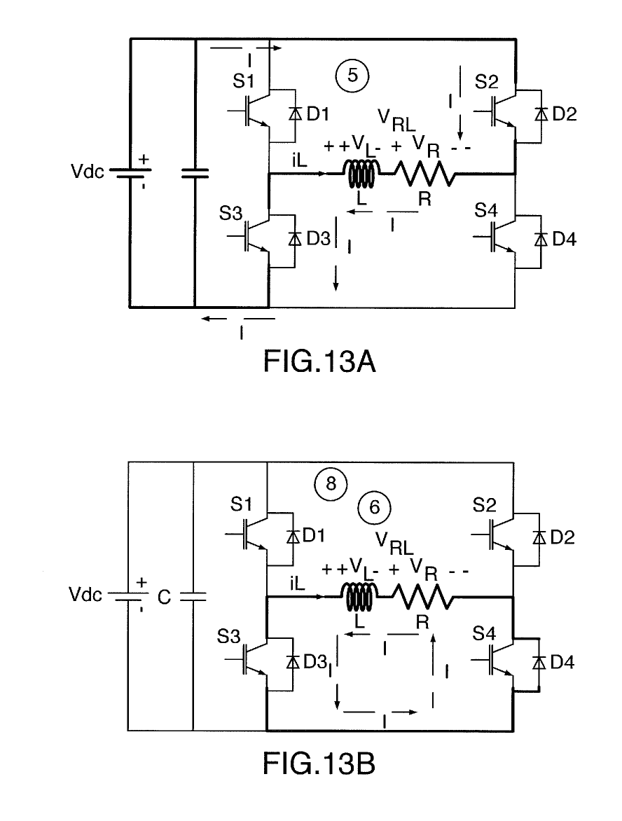

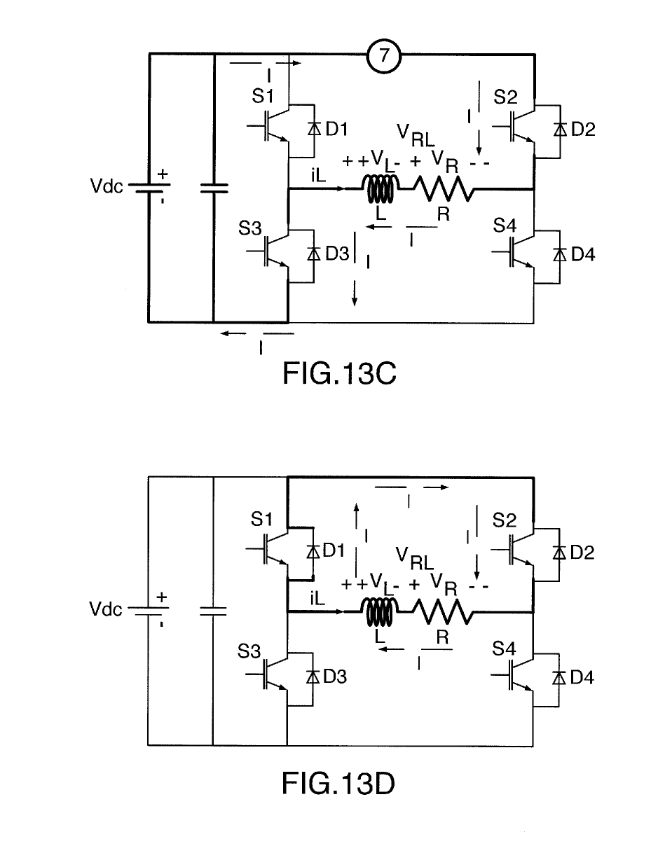

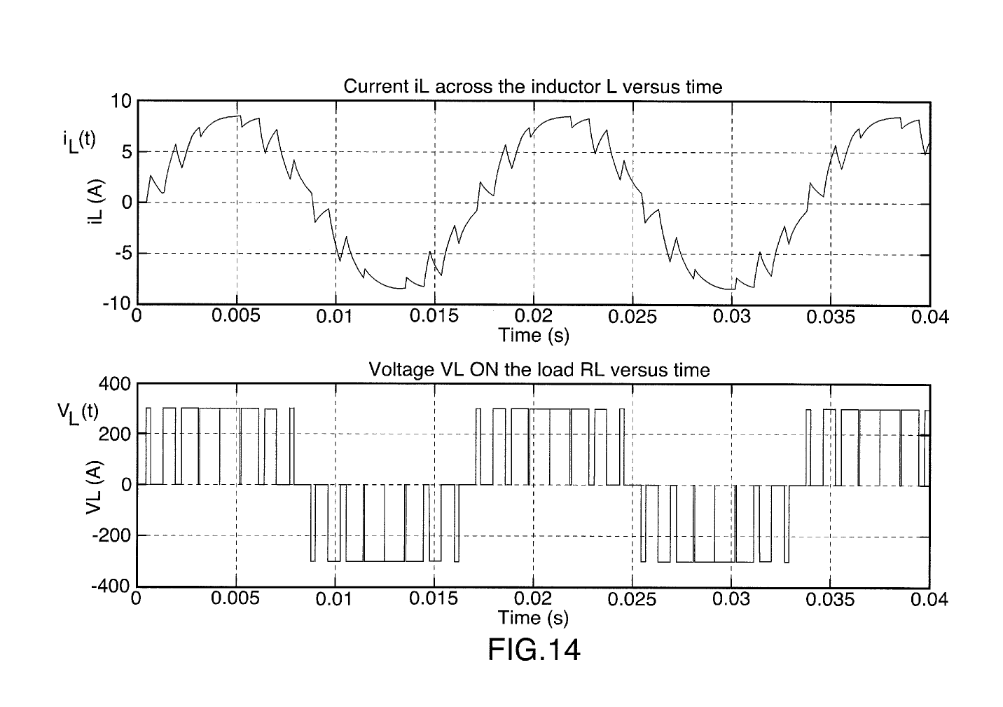

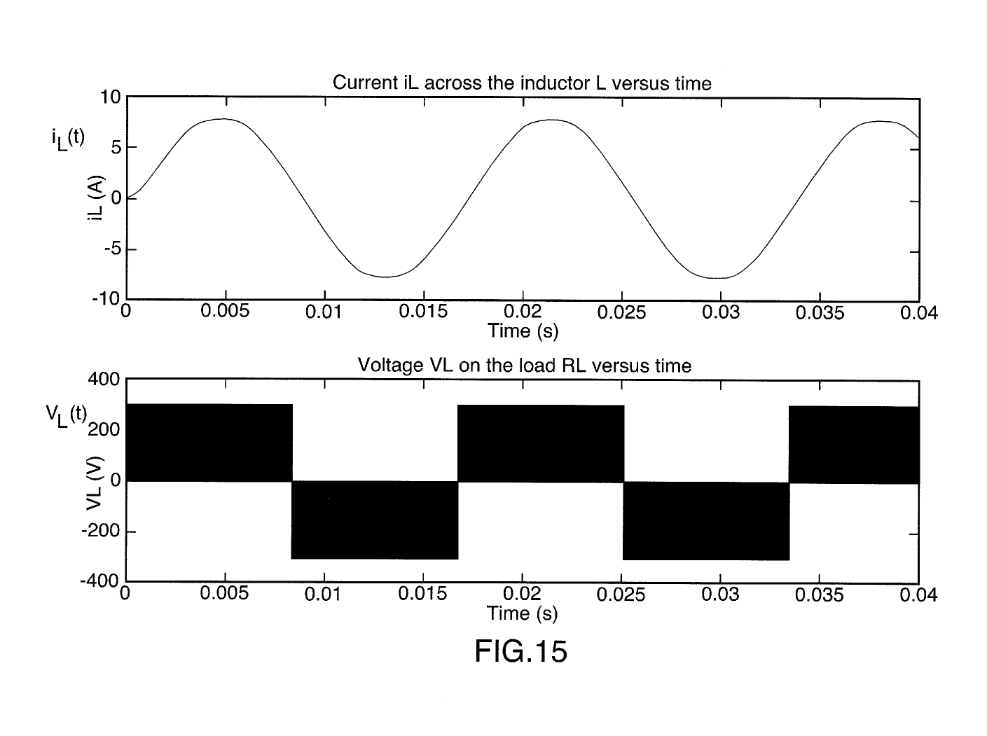

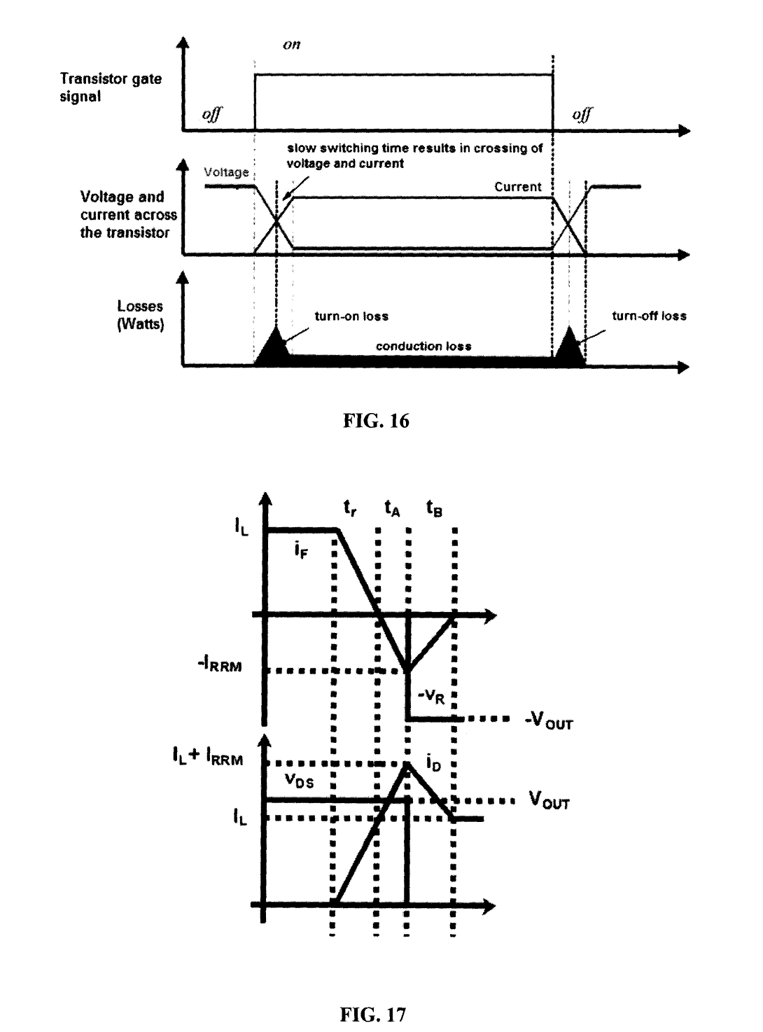

The skilled addressee will appreciate that this particular arrangement enables to greatly reduce the output losses of the converter while providing a high switching frequency. This high switching frequency enables to reduce the size of the passive components (the capacity and the inductor in the embodiment illustrated in FIG. 4) and the overall cost of the converter, which is of great advantage, particularly in the case where the power converter is provided on a printed circuit board.

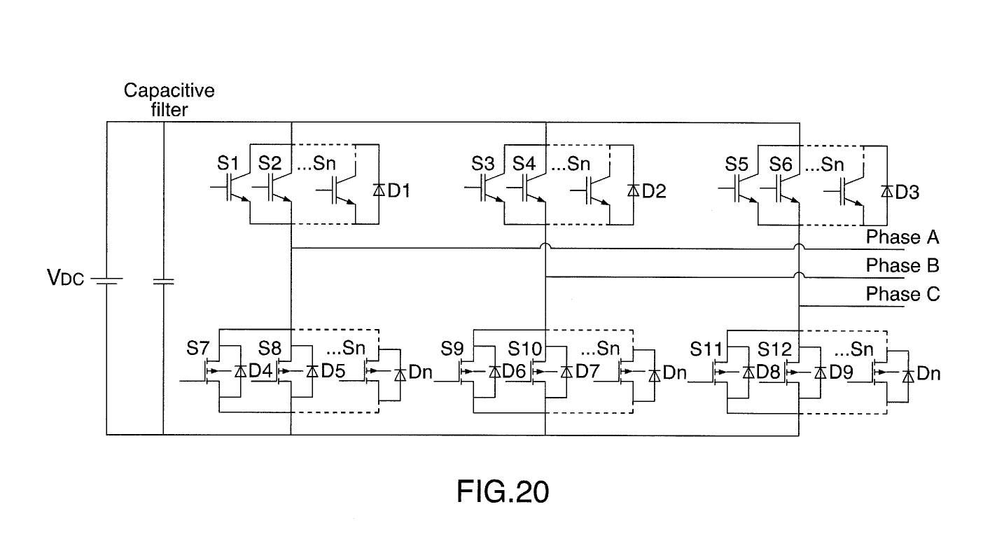

The dual switching frequency hybrid power converter will now be described with reference to FIG. 18 which shows a mono-phase converter but the skilled addressee will appreciate that three phase and multi-phase power converters may be provided according to the principles described herein, as further described thereinafter with reference to FIG. 20.

Referring to FIG. 18, there is shown a dual switching frequency hybrid power converter adapted to be connected between a first element and a second element for voltage conversion, i.e. a DC element and an AC element in the illustrated case. In the illustrated case, the converter is used for converting a DC voltage to an AC voltage but it should be understood that conversion from an AC source to a DC source may also be performed, as well as a DC to DC conversion or even an AC to AC conversion, as detailed thereinafter.

The dual switching frequency hybrid power converter comprises a first leg electrically connected to the DC element, a DC power source in the illustrated case. The first leg comprises a high side switch and a low side switch serially connected. The high side switch comprises a selected one of a first switching element having low conduction losses and a second switching element having low commutation losses. In the illustrated embodiment, the high side switch of the first leg comprises an IGBT.

The low side switch comprises the remaining of a first switching element having low conduction losses and a second switching element having low commutation losses. In the illustrated case, the low side switch of the first leg comprises a MOSFET since an IGBT has been selected for the high side switch of the first leg. The skilled addressee will nevertheless appreciate that an inverted configuration may be selected.

The first leg further comprises an anti-parallel diode operatively connected in a parallel relationship with the IGBT. In one embodiment, the anti-parallel diode may be integrated to the IGBT but the skilled addressee will appreciate that a diode not integrated with the IGBT may be alternatively used.

The dual switching frequency hybrid power converter comprises a second leg electrically connected to the DC source in a parallel relationship with the first leg. The second leg comprises a high side switch and a low side switch serially connected. The high side switch comprises a selected one of a first switching element having low conduction losses and a second switching element having low commutation losses corresponding to the one selected for the high side switch of the first leg. In other words, the selection of the type of switching elements that is made for the second leg depends on the selection used for the first leg. In the illustrated case, the high side switch of the second leg comprises an IGBT since the high side switch of the first leg comprises an IGBT.

The low side switch of the second leg comprises the remaining of a first switching element having low conduction losses and a second switching element having low commutation losses. In the illustrated case, the low side switch of the second leg comprises a MOSFET since an IGBT has been selected for the high side switch of the second leg.

The second leg further comprises an anti-parallel diode operatively connected in a parallel relationship with the IGBT. In one embodiment, the anti-parallel diode may be integrated to the IGBT but the skilled addressee will appreciate that a diode not integrated with the IGBT may be used.

As it will be more clearly detailed below, each of the first switching elements is operated at a low fundamental frequency and each of the second switching elements is operated at a high frequency greater than the low fundamental frequency.

In one embodiment, the low fundamental frequency is comprised between 1 Hz and 1000 Hz. In a further embodiment, the low fundamental frequency is 60 Hz while in another embodiment, the low fundamental frequency is 50 Hz.

In one embodiment, the high frequency is comprised between 1 kHz and 1 MHz although greater values may also be considered for a given application.

The skilled addressee will appreciate that various arrangements may be envisaged for the low fundamental frequency and the high frequency, as long as the two frequencies are distinct enough.

FIG. 19 illustrates the general principle of the switching of the switching elements.

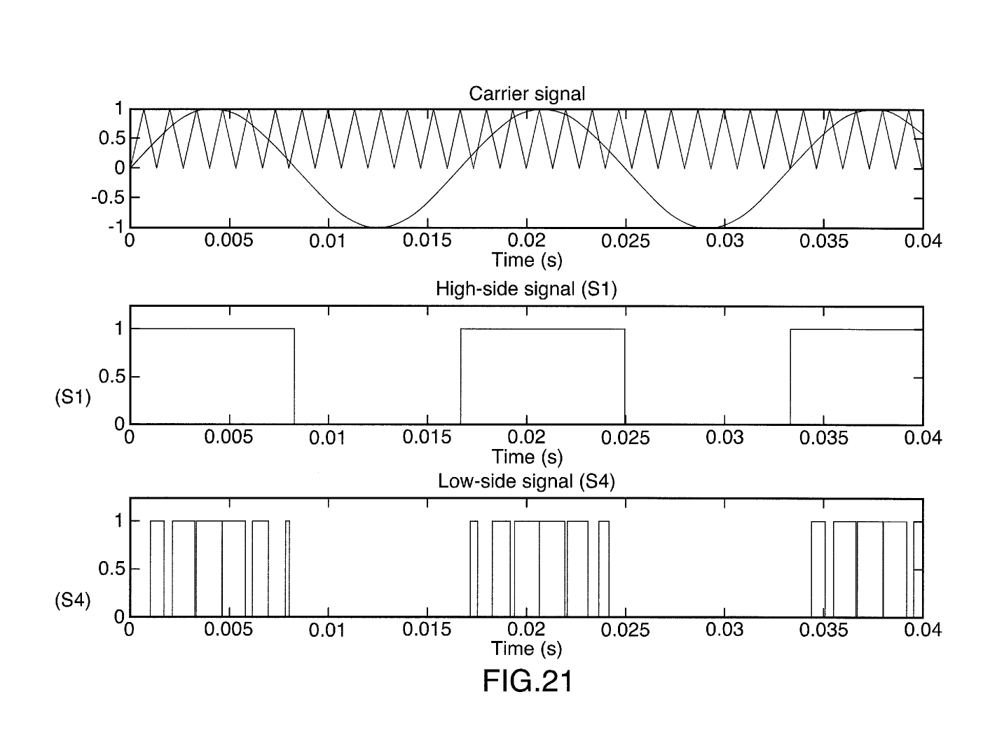

Referring to FIGS. 21 to 23, an exemplary embodiment of the control signals used to operate the switching elements S1 to S4 of FIG. 18 will be described. The skilled addressee will appreciate that each of these control signals is electrically connected to the gate of the corresponding switching element to command a conducting state or a blocked state thereof.

In the illustrated embodiment, as shown in FIG. 21, a sinusoidal reference is compared with a triangular carrier signal to produce the low-side control signals. When the sinusoidal reference is greater than the carrier signal, the control signal for the switching element S4 is high and when the sinusoidal reference is lower than the carrier signal, the control signal for the switching element S4 is low. The control signal for the switching element S1 is high when the sinusoidal reference is positive while it is low when the sinusoidal reference is negative. In other words, the switching element S1 is operated at the same low frequency than the sinusoidal reference while the switching element S4 is operated at a greater frequency.

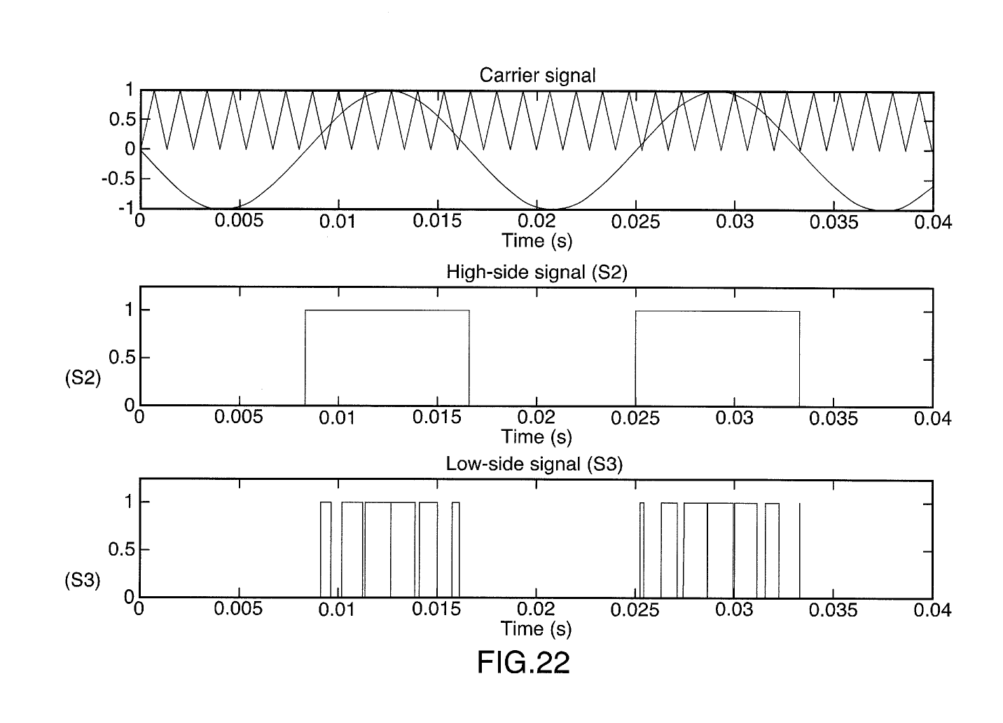

FIG. 22 shows the generation of the control signal for the switching elements S2 and S3. As illustrated, the sinusoidal reference used in FIG. 21 is inverted and compared to the same triangular carrier signal. When the sinusoidal reference is greater than the carrier signal, the control signal for the switching element S3 is high and when the sinusoidal reference is lower than the carrier signal, the control signal for the switching element S3 is low. The control signal for the switching element S2 is high when the sinusoidal reference is positive while it is low when the sinusoidal reference is negative. In other words, the switching element S2 is operated at the same low frequency than the sinusoidal reference while the switching element S3 is operated at a greater frequency.

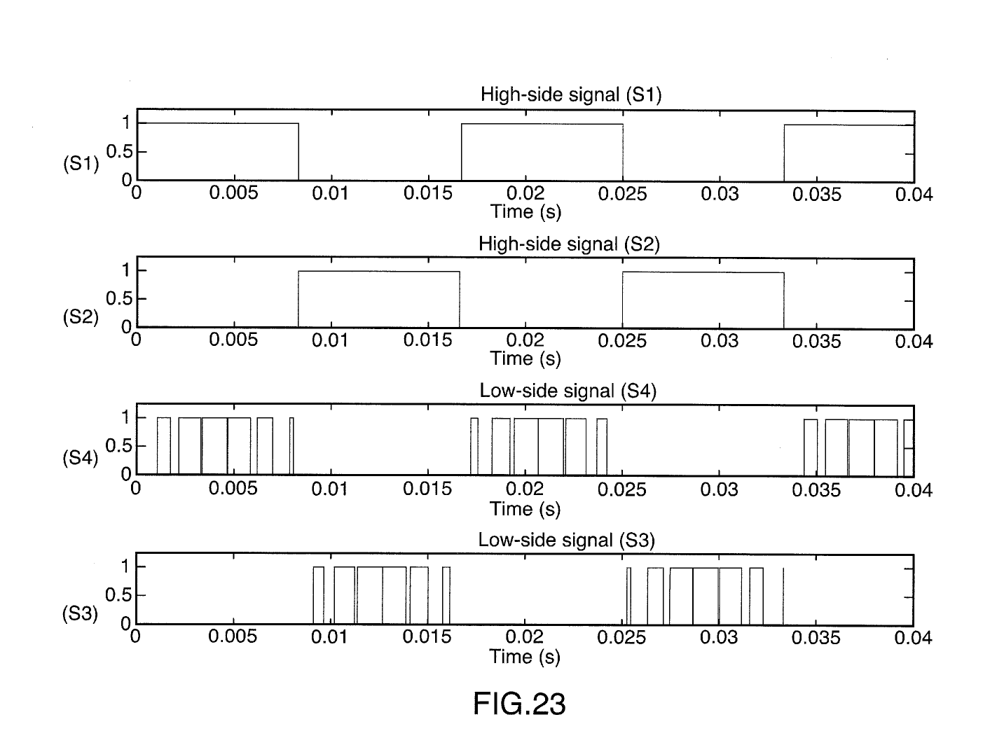

As better shown in FIG. 23, a single one of the high side switching elements S1 and S2 is activated at the same time. Moreover, a single one of the low side switching elements S3 and S4 is activated at the same time. Furthermore, a single one of the switching elements of the same leg is also activated at the same time.

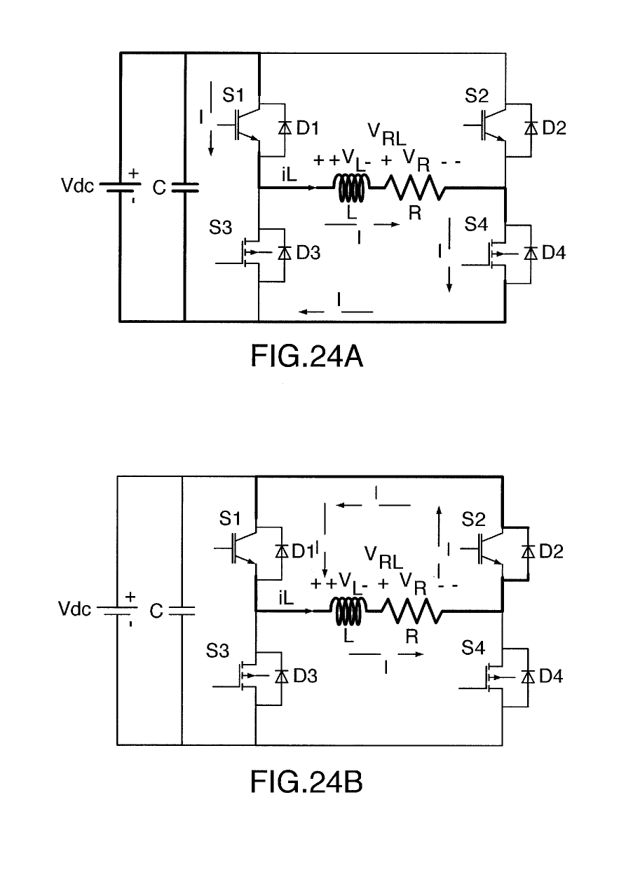

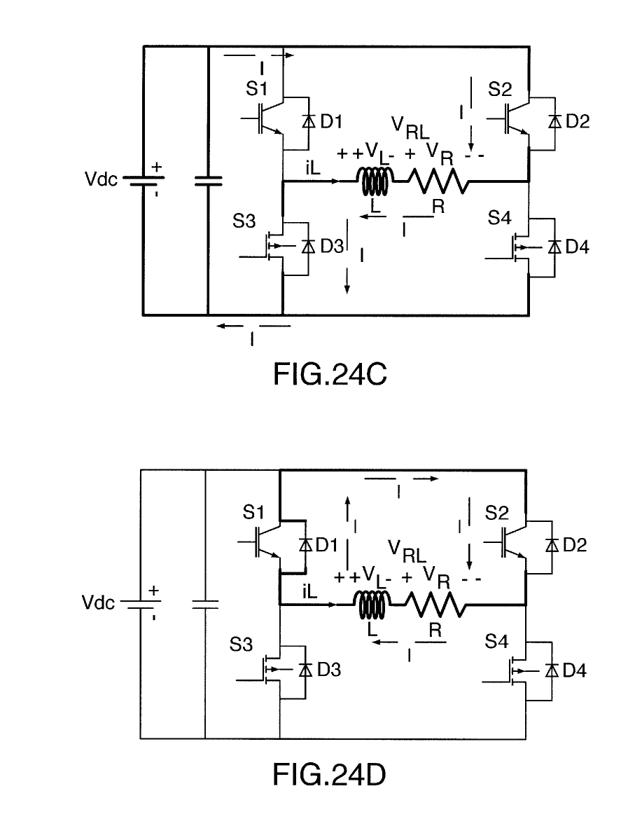

In section A of FIG. 23, it can be seen that the control signal for the switching element S1 is high while the control signal for the switching element S4 is alternatively switched between a low state and a high state. The control signals for S2 and S3 are low so that S2 and S3 do not conduct. When both control signals for S1 and S4 are high, the load is connected to the DC voltage, as shown in FIG. 24A, so that the current therein is increasing.

When S4 is turned OFF, the current of the load runs through D2 and S1, as shown in FIG. 24B, so that the current slightly decreases. This sequence is operated as long as S1 is in its high state.

In section B of FIG. 23, it can be seen that the control signal for the switching element S2 is high while the control signal for the switching element S3 is alternatively switched between a low state and a high state. The control signals for S1 and S4 are low so that S1 and S4 do not conduct. When both control signals for S2 and S3 are high, the load is connected to the DC voltage, as shown in FIG. 24C, so that the current therein is increasing.

When S3 is turned OFF, the current of the load runs through D1 and S2, as shown in FIG. 24D, so that the current slightly decreases. This sequence is operated as long as S2 is in its high state.

Then, S1 and S4 are used again, as in section A.

The skilled addressee will appreciate that this embodiment of an operating sequence enables to not use the diode of the MOSFETs, which if of great advantage, as previously explained.

The skilled addressee will appreciate that the above described operating sequence of the switching elements is suitable for the cases wherein the load is a resistive load. However, the skilled addressee will also appreciate that the described sequence may not be suitable for a capacitive or an inductive load, i.e. the power factor of the load is lower than 1.

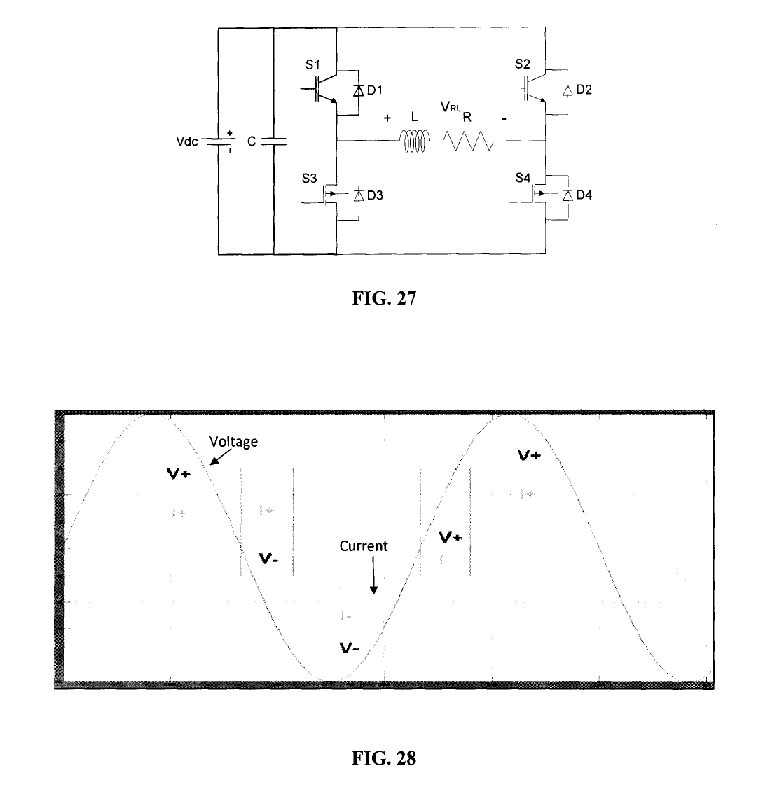

Indeed, referring to FIG. 27, according to the principle of the invention, when the voltage and the current across the load are both positive, S1, S4 and D2 are activated, S4 enables the modulation. When S4 is stopped, D2 becomes active and enables a free wheel operation therethrough. When the voltage and the current across the load are both positive, S2, S3 and D1 are activated, S3 enables the modulation. When S3 is stopped, D1 becomes active and enables a free wheel operation therethrough.

As shown in FIG. 28, in the case where the load is a capacitive load or an inductive load, there is a phase difference between the voltage and the current across the load. The operating sequence of the power converter should be adapted to this particular case.

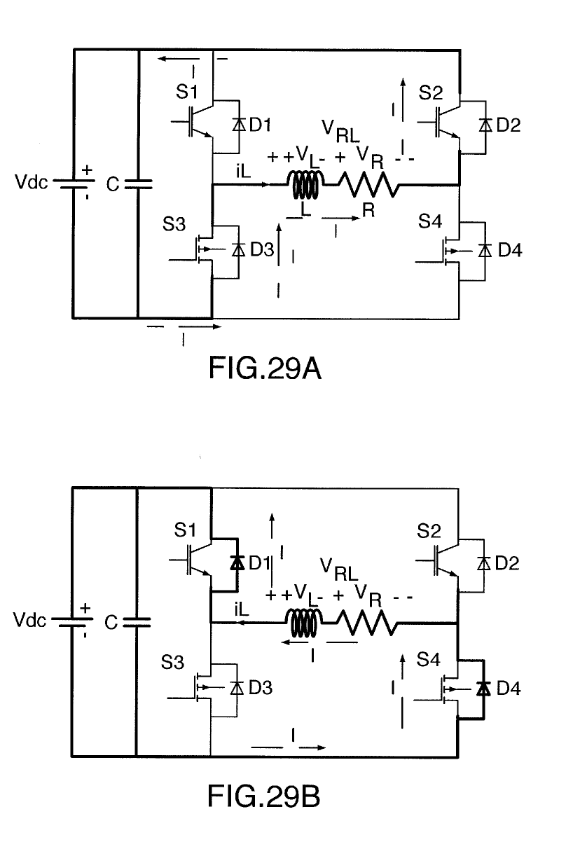

Indeed, when the voltage becomes negative but the current is still positive, S1 and S4 stop. Because of the voltage across the load, D2 and D3 conduct, as illustrated in FIG. 29A. Since D2 and D3 conduct, S2 and S3 cannot be activated and the operating sequence for converting the voltage cannot be performed.

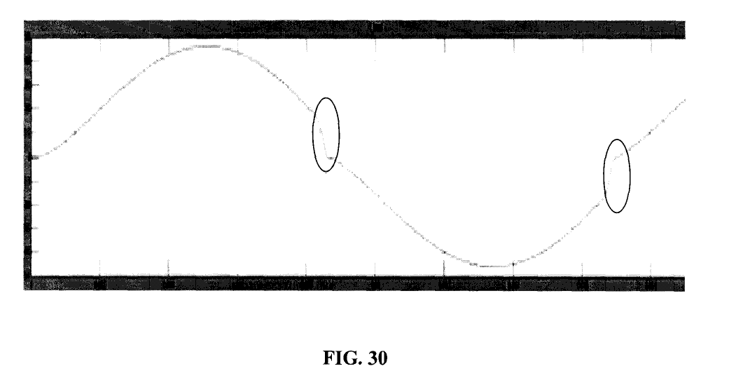

Similarly, when the voltage becomes positive but the current is still negative, D1 and D4 conduct and prevent the activation of 51 and S4, as illustrated in FIG. 29B. In this case, one can not modulate the voltage of the load in order to provide a sinusoidal current. Indeed, as illustrated in FIG. 30, this phenomena will create a distortion of the current, which is unacceptable for given applications.

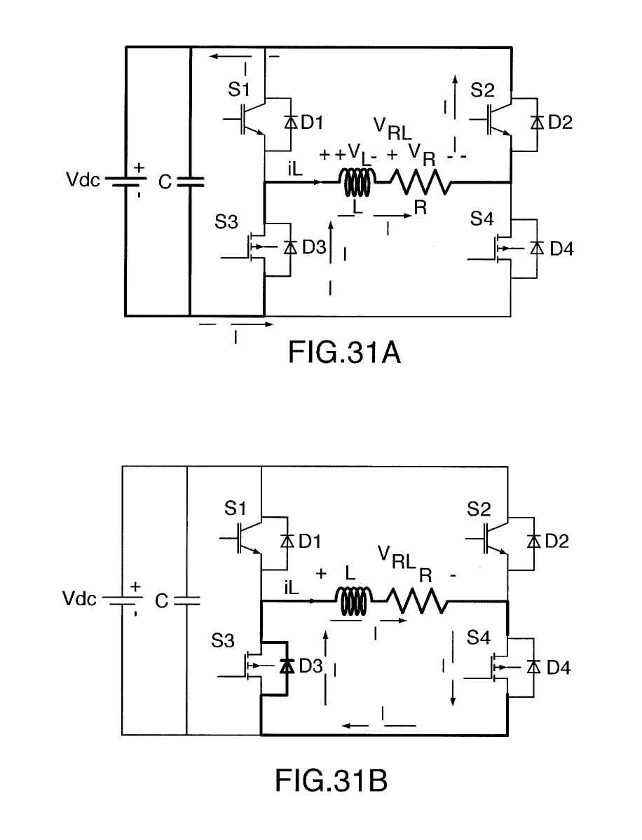

Referring now to FIGS. 31A and 31B, in order to overcome this issue, D1 and D2 may be blocked to prevent their conduction according to a given sequence. This enables a sinusoidal modulation of the current, which is of great advantage.

For example, in one embodiment, when the voltage becomes negative but the current is still positive, S4 is triggered in order to block D2. If D2 and D3 conduct, the current decreases linearly in a fast manner. On the contrary, when S4 is triggered, D2 becomes blocked and the current across the load still decreases, but more slowly. Thus, it becomes possible to modulate the current across the load with the control signals controlling S4. In this manner, a sinusoidal current may be obtained.

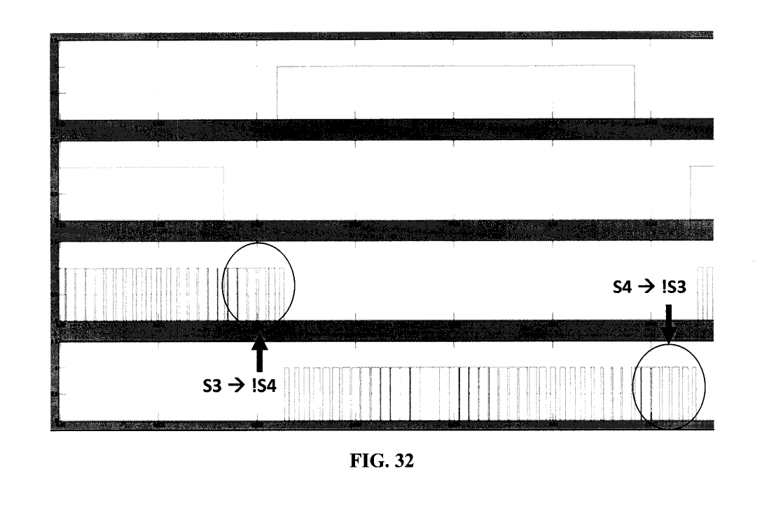

In this embodiment, the control signal controlling S4 is similar to the inverted control signal controlling S3, as previously detailed for the case of a resistive load. FIG. 32 illustrates the control signal for S1 to S4 for the case of a load which is not a resistive one.

While the operating sequence of the switching elements has been described for a mono-phase converter, the skilled addressee will appreciate that it can be adapted for a three-phase or any multi-phase converter. Moreover, the skilled addressee will also appreciate that a voltage conversion from an AC source to a DC source may also be implemented.

In one embodiment, the dual switching frequency hybrid power converter further comprises a third leg electrically connected to the first element in a parallel relationship with the first leg and the second leg. The third leg comprises a high side switch and a low side switch serially connected, the high side switch comprising a selected one of a first switching element having low conduction losses and a second switching element having low commutation losses corresponding to the one selected for the high side switch of the first leg, as previously detailed. The low side switch comprises the remaining of a first switching element having low conduction losses and a second switching element having low commutation losses. The third leg further comprises an anti-parallel diode operatively connected in a parallel relationship with the first switching element, thereby providing a three phase power converter.

FIG. 20 illustrates a three-phase converter comprising a third leg wherein a plurality of elementary switching elements of the same type is connected together in a parallel relationship in order to enable more current in each of the semi-legs of the converter. This arrangement is of great advantage for reducing output losses of the converter since the diode of the MOSFETs are still not used.

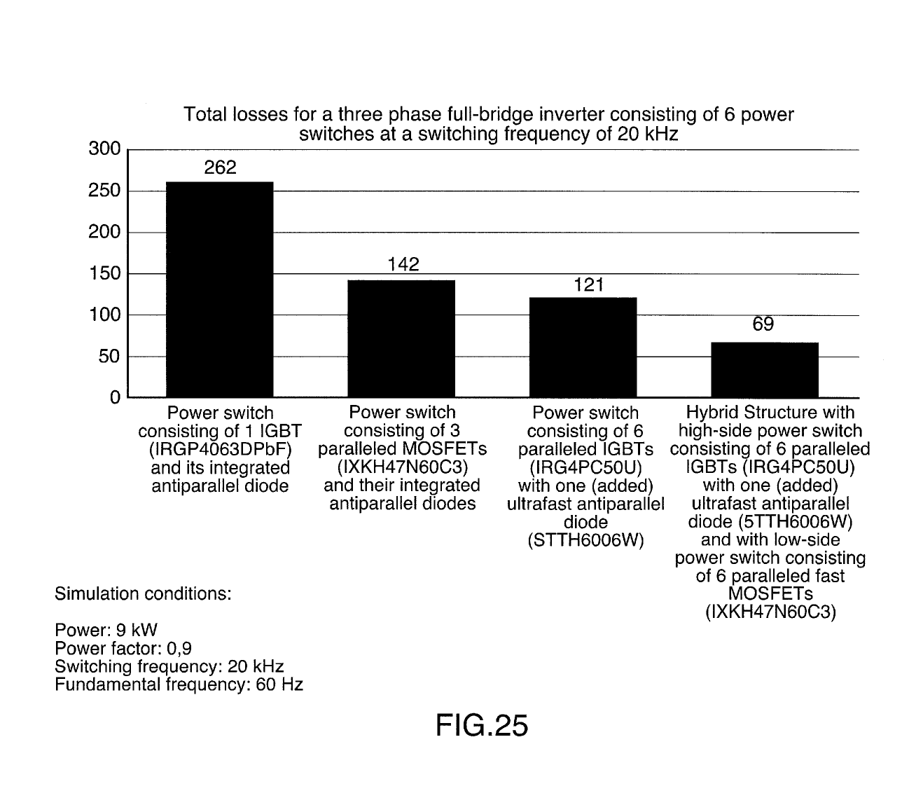

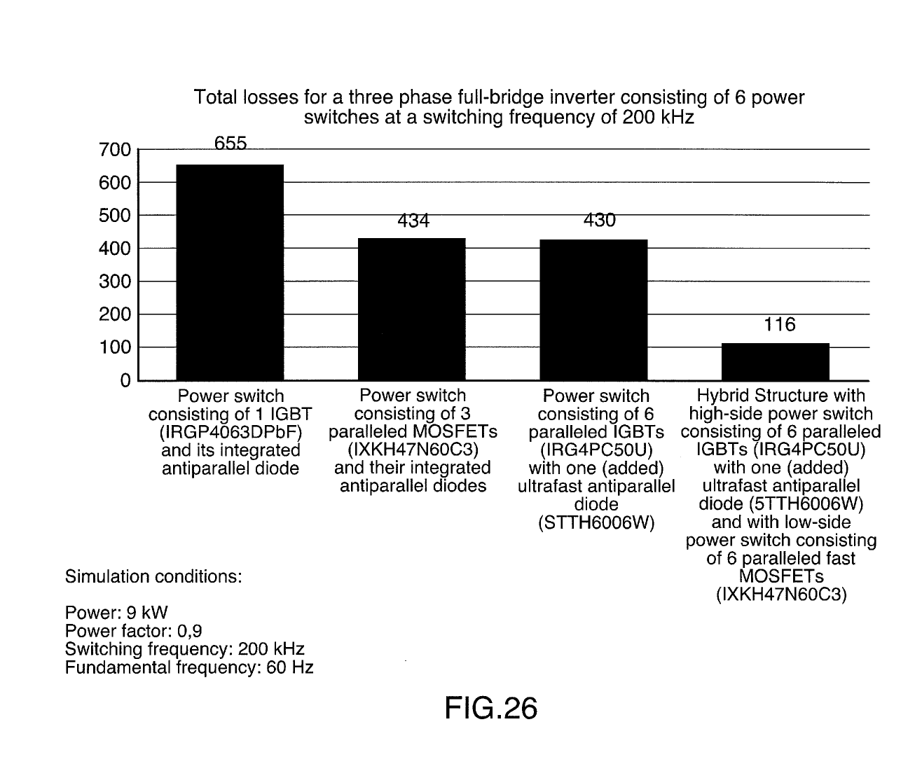

The above-described topology has been tested and validated with simulation tools, as better shown in FIGS. 25 and 26. FIG. 25 illustrates the overall losses for different configurations of a three-phase converter for a switching frequency of 20 kHz while FIG. 26 illustrates the overall losses for different configurations of a three-phase converter for a switching frequency of 200 kHz. FIG. 25 shows that the overall losses of a converter may be reduced by a factor 4 when using a configuration similar to the one described above at a switching frequency of 20 kHz. FIG. 26 shows that the overall losses of a converter may be even more reduced when using a configuration similar to the one described above at a switching frequency of 200 kHz.

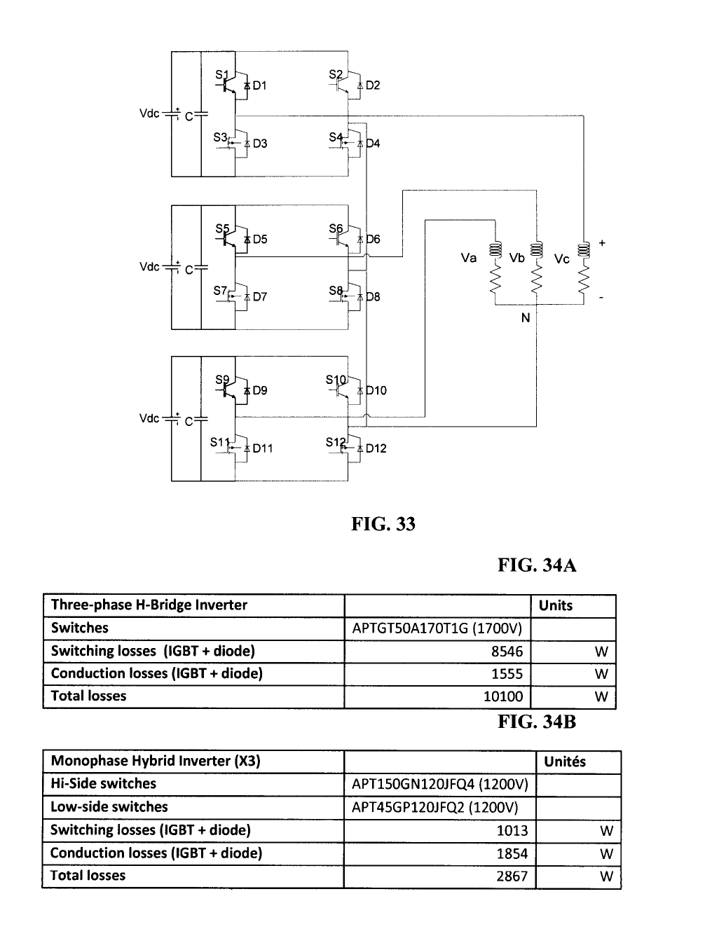

Referring now to FIG. 33, there is shown another embodiment of a three-phase dual switching frequency hybrid power converter for a three-phase load. The three-phase power converter comprises a first, a second and a third dual switching frequency hybrid power converter as previously defined. Each of the first, second and third power converter is operatively connected to a corresponding phase of the three-phase load. Although three DC power sources are shown, it should be mentioned that a single DC power source may be used. The neutral conductor of the load is operatively connected to each of the three power converter, as illustrated.

The embodiment shown in FIG. 33 is of great advantage with respect to the typical power converters of the art. Indeed, with this embodiment, the required DC voltage may be lower than in the case of a typical power converter in order to generate a given output voltage. For example, a DC voltage of 490V is required to generate an output voltage of 347V between one of the phases and the neutral conductor. With a three-phase power converter of the prior art having three legs, a DC voltage of 848V is required in order to provide the same output voltage of 347V.

The above disclosed embodiment is of great advantage since it enables to greatly reduce the overall losses of the power converter. Indeed, the required switching elements may have a reduced size since they are adapted for a reduced voltage. These switching elements may thus be faster, thereby reducing the losses associated to the commutation time. Moreover, since the DC voltage is reduced, the commutation losses may also be reduced.

FIGS. 34A and 34B show the overall losses simulated for a power converter according to the invention and a typical power converter respectively. The simulation has been made for an output power of 200 kW with a power factor of 0.8, a voltage of 347 V between a phase and the neutral conductor and a current of 240 Arms with a DC power source of 570 V.

With a typical power converter, there are three IGBTs mounted in parallel for each switching element, for a total of 18 IGBTs. The used switching frequency is 20 kHz. FIG. 34A shows the losses. The switching elements have a reduced speed since they are adapted for a high voltage, i.e. the DC bus is at 1000 V. This increases the losses.

FIG. 34A shows the losses with a three phase power converter comprising three mono-phase power converter according to the invention. The high-side switches are operated at a low fundamental frequency of 60 Hz. Each mono-phase power converter comprises 12 IGBTs, thus the three-phase power converter comprises 36 IGBTs.

The switching elements have been chosen to support two times the voltage of the DC source. One can see that the commutation losses are greatly lowered with respect to the typical power converter, which is of great advantage.

The conduction losses are however greater since more switching elements conduct at the same time. The skilled addressee will nevertheless appreciate that the overall losses are reduced by a factor of 3.5 with respect to a typical power converter.

The skilled addressee will appreciate that the dual switching frequency hybrid power converter as previously defined may be used for converting an AC voltage into a DC voltage or for converting a DC voltage into an AC voltage or even for converting an AC voltage into another AC voltage. As previously mentioned, a conversion from a DC voltage to another DC voltage may also be considered. The conversion is done between a first element and a second element. The first element and the second element being a DC voltage source and a DC load.

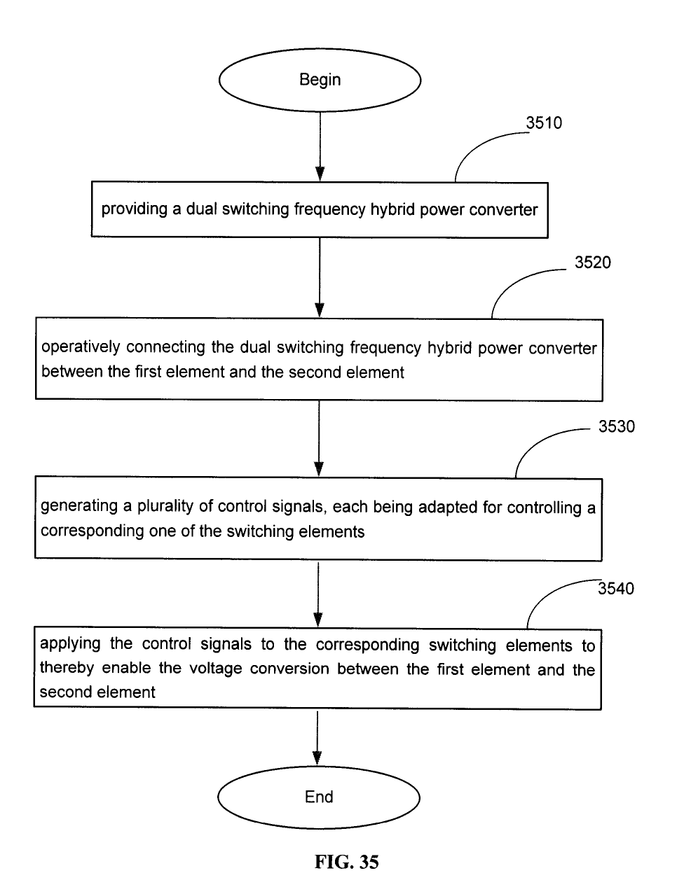

According to another aspect, there is also provided a method for voltage conversion between a first element and a second element, as illustrated in FIG. 35.

At processing step 3510, a dual switching frequency hybrid power converter as previously defined is provided.

At processing step 3520, the dual switching frequency hybrid power converter is operatively connected between the first element and the second element.

At processing step 3530, a plurality of control signals is generated, each being adapted for controlling a corresponding one of the switching elements.

At processing step 3540, the control signals are applied to the corresponding switching elements to thereby enable the voltage conversion between the first element and the second element.

Although the above description relates to specific preferred embodiments as presently contemplated by the inventors, it will be understood that the invention in its broad aspect includes functional equivalents of the elements described herein. For example, throughout the present description and in the illustrating Figures, the selected high side switching elements comprise IGBTs and the selected low side switching elements comprise MOSFETs. The skilled addressee will appreciate that the IGBTs may be used for the low side switching elements while the MOSFETS may be used for the high side switching elements, as long as the operating sequence thereof is adapted to use each type of switching elements in its optimal frequency range, as detailed above.

1-22. (canceled)

23. A dual switching frequency hybrid power converter adapted to be connected between a first element and a second element for voltage conversion, said dual switching frequency hybrid power converter comprising:
a first leg electrically connected to the first element, said first leg comprising a high side switch and a low side switch serially connected, the high side switch comprising a selected one of a first switching element having low conduction losses and a second switching element having low commutation losses and the low side switch comprising the remaining of a first switching element having low conduction losses and a second switching element having low commutation losses, said first leg further comprising an anti-parallel diode operatively connected in a parallel relationship with the first switching element; and
a second leg electrically connected to the first element in a parallel relationship with the first leg, said second leg comprising a high side switch and a low side switch serially connected, the high side switch comprising a selected one of a first switching element having low conduction losses and a second switching element having low commutation losses corresponding to the one selected for the high side switch of the first leg and the low side switch comprising the remaining of a first switching element having low conduction losses and a second switching element having low commutation losses, said second leg further comprising an anti-parallel diode operatively connected in a parallel relationship with the first switching element;
wherein each of the first switching elements is operated at a low fundamental frequency and each of the second switching elements is operated at a high frequency greater than the low fundamental frequency for enabling a bidirectional voltage conversion between the first element and the second element.

24. The dual switching frequency hybrid power converter according to claim 23, wherein each of said first switching elements comprises at least one IGBT.

25. The dual switching frequency hybrid power converter according to claim 23, wherein each of said first switching elements is selected from a group consisting of a thyristor, a GTO, an IGCT and a MCT.

26. The dual switching frequency hybrid power converter according to claim 23, wherein each of said second switching elements comprises at least one of a MOSFET and a fast IGBT.

27. The dual switching frequency hybrid power converter according to claim 23, wherein each of said first switching elements comprises a plurality of switching devices connected in parallel.

28. The dual switching frequency hybrid power converter according to claim 23, wherein each of said second switching elements comprises a plurality of switching devices connected in parallel.

29. The dual switching frequency hybrid power converter according to claim 23, wherein the anti-parallel diode is integrated with the first switching element.

30. The dual switching frequency hybrid power converter according to claim 23, wherein each of said first leg and second leg comprises an additional anti-parallel diode operatively connected in a parallel relationship with the corresponding second switching element.

31. The dual switching frequency hybrid power converter according to claim 23, further comprising a third leg electrically connected to the first element in a parallel relationship with the first leg and the second leg, said third leg comprising a high side switch and a low side switch serially connected, the high side switch comprising a selected one of a first switching element having low conduction losses and a second switching element having low commutation losses corresponding to the one selected for the high side switch of the first leg and the low side switch comprising the remaining of a first switching element having low conduction losses and a second switching element having low commutation losses, said third leg further comprising an anti-parallel diode operatively connected in a parallel relationship with the first switching element, thereby providing a three phase power converter.

32. The dual switching frequency hybrid power converter according to claim 23, wherein said low fundamental frequency is comprised between 1 Hz and 1000 Hz.

33. The dual switching frequency hybrid power converter according to claim 32, wherein said low fundamental frequency is 60 Hz.

34. The dual switching frequency hybrid power converter according to claim 23, further comprising a control unit controlling a plurality of control signals, each of said control signals controlling operation of a corresponding one of the switching elements.

35. The dual switching frequency hybrid power converter according to claim 23, wherein the first element comprises a DC element.

36. The dual switching frequency hybrid power converter according to claim 23, wherein the second element comprises an AC element.

37. A three-phase dual switching frequency hybrid power converter for a three-phase load, said three-phase power converter comprising a first, a second and a third dual switching frequency hybrid power converter as defined in claim 23, each being operatively connected to a corresponding phase of the three-phase load.

38. Use of the dual switching frequency hybrid power converter as defined in claim 23 for converting an AC voltage into a DC voltage.

39. Use of the dual switching frequency hybrid power converter as defined in claim 23 for converting a DC voltage into an AC voltage.

40. Use of the dual switching frequency hybrid power converter as defined in claim 23 for converting an AC voltage into another AC voltage.

41. Use of the dual switching frequency hybrid power converter as defined in claim 23 for converting a DC voltage into another DC voltage.

42. A method for voltage conversion between a first element and a second element, said method comprising:
providing a dual switching frequency hybrid power converter as defined in claim 23;
operatively connecting the dual switching frequency hybrid power converter between the first element and the second element;
generating a plurality of control signals, each being adapted for controlling a corresponding one of the switching elements; and
applying the control signals to the corresponding switching elements to thereby enable said voltage conversion between the first element and the second element.
